(19) United States
(12) Patent Application Publication
(10) Pub. No.: US 2018/0341946 A1
(43) Pub. Date: Nov. 29, 2018

(54) AUTHENTICATION OF CUSTOMER REDEMPTION ACCOUNT WHEN REDEEMING POINTS

(71) Applicant: MASTERCARD ASIA/PACIFIC PTE LTD, Singapore (SG)

(72) Inventors: Michihiko YODEN, Singapore (SG); Holger KUNKAT, Neumuenster (DE); Axel Emile Jean Charles CATELAND, Scarsdale, NY (US); Harjender SINGH, Singapore (SG)

(73) Assignee: MASTERCARD ASIA/PACIFIC PTE LTD, Singapore (SG)

(21) Appl. No.: 15/828,789

(22) Filed: Dec. 1, 2017

Related U.S. Application Data
(60) Provisional application No. 62/429,170, filed on Dec. 2, 2016.

(51) Int. Cl. G06Q 20/38; G06Q 30/02; G06Q 20/40; G06Q 20/32

(52) U.S. Cl. CPC G06Q 20/38215; G06Q 20/3224; G06Q 20/401; G06Q 30/0226

(57) ABSTRACT

A payment interface apparatus configured to facilitate a transaction comprising a request to update redemption points recorded in a customer redemption account, the payment interface apparatus comprising: an input port to receive the request to update redemption points recorded in a customer redemption account and data fields in support of the request; a processor; and at least one memory including computer program code; the at least one memory and the computer program code configured to, with the at least one processor, cause the payment interface apparatus at least to: authenticate the request using a selection of at least the received data fields that are attributable to transaction specific parameters, the transaction specific parameters being data elements unique to the transaction; and effect the update in the redemption points recorded in the customer redemption account in response to successful authentication of the request.

### FIELD OF INVENTION

The present invention relates broadly, but not exclusively, to authenticating a transaction comprising a request to update redemption points in a customer redemption account.

### BACKGROUND

Loyalty reward programmes are marketing strategies designed to encourage consumers to continue to purchase or use the goods and services provided by the businesses associated with such loyalty reward programmes. A typical loyalty reward programme implemented by a business or merchant generally includes a loyalty card which identifies the consumer as a member of the loyalty programme. The loyalty card would be presented by the consumer at the point of transaction to the merchant. Alternatively, the loyalty card may be stored in digital form, such as in a digital wallet, in a smart phone with an advanced mobile operating system. By presenting the card, in either physical or digital form, the consumer would initiate a request to earn redemption points from a purchase made at a participating merchant or offset the purchase made using redemption points accumulated from previous purchases.

Given that an accumulation of redemption points could lead to redemption of substantial monetary value, it becomes important to ensure the authenticity of a transaction that includes a request to update redemption points stored in a customer redemption account. For instance, it is possible to intercept data transmitted over a NFC (near field communication) channel used to initiate a transaction with such a request,

The present application provides detail on one possible approach to perform such authentication.

### SUMMARY

According to a first aspect of the present invention, there is provided a payment interface apparatus configured to facilitate a transaction comprising a request to update redemption points recorded in a customer redemption account, the payment interface apparatus comprising: an input port to receive the request to update redemption points recorded in a customer redemption account and data fields in support of the request; a processor; and at least one memory including computer program code; the at least one memory and the computer program code configured to, with the at least one processor, cause the payment interface apparatus at least to: authenticate the request using a selection of at least the received data fields that are attributable to transaction specific parameters, the transaction specific parameters being data elements unique to the transaction; and effect the update in the redemption points recorded in the customer redemption account in response to successful authentication of the request.

According to a second aspect of the present invention, there is provided a method for facilitating a transaction comprising a request to update redemption points recorded in a customer redemption account, the method comprising: receiving, at a payment interface apparatus, the request to update redemption points recorded in a customer redemption account and data fields in support of the request; authenticating the request using a selection of at least the received data fields that are attributable to transaction specific parameters, the transaction specific parameters being data elements unique to the transaction; and effecting the update in the redemption points recorded in the customer redemption account in response to successful authentication of the request.

According to a third aspect of the present invention, there is provided a non-transitory computer readable medium having stored thereon executable instructions for controlling a payment interface apparatus to facilitating a transaction comprising a request to update redemption points recorded in a customer redemption account by performing steps comprising receiving, at a payment interface apparatus, the request to update redemption points recorded in a customer redemption account and data fields in support of the request; authenticating the request using a selection of at least the received data fields that are attributable to transaction specific parameters, the transaction specific parameters being data elements unique to the transaction; and effecting the update in the redemption points recorded in the customer redemption account in response to successful authentication of the request.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a schematic of components in a system 100 that can support a transaction in which redemption for value added services occurs.

FIG. 2 shows detail of a message exchange sequence that occurs between a mobile terminal and a payment interface apparatus, where the payment interface apparatus is implemented using a sole payment terminal.

FIG. 3 shows detail of a message exchange sequence that occurs between a mobile terminal and a payment interface apparatus, where the payment interface apparatus includes a payment terminal coupled to a point of sale (POS) terminal.

FIG. 4 is a schematic of a computing device used to implement the payment interface apparatus shown in FIGS. 1 to 3.

FIG. 5 shows a method, in accordance with one embodiment of the invention, for facilitating a transaction comprising a request to update redemption points recorded in a customer redemption account.

### DETAILED DESCRIPTION

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a conventional computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of the preferred method.

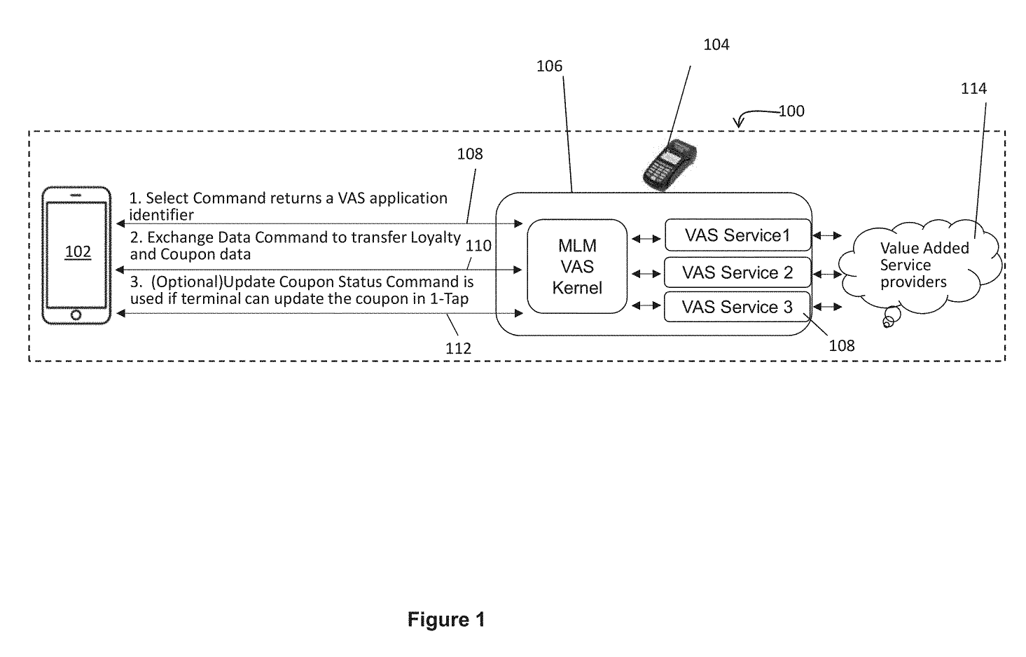

FIG. 1 shows a schematic of components in a system 100 that can support a transaction in which redemption for value added services occurs. Value added services (VAS) refer to incentives that are provided by a merchant for spending at the merchant and these incentives may be accessed through one or more loyalty, coupon, voucher or reward programmes. Benefits that result from such programmes include a financial discount or rebate when purchasing a product and/or service or a gift. A customer participates in each of these programmes by registering a customer redemption account, which will be used to keep track of redemption points accumulated in each customer redemption account.

The transaction that the system 100 supports may refer to a financial transaction where goods or services are purchased from a merchant. Such a transaction would also update redemption points in respect of the purchase, so that the transaction includes a request to update redemption points recorded in a customer redemption account. For example, the recorded redemption points would increase should the customer choose to let the purchase earn redemption points, or the recorded redemption points would decrease should the customer choose to use his accumulated redemption points to offset the purchase. Alternatively, the transaction may not have a purchase component to it, for example if the customer has a ticket that awards redemption points, whereby the transaction then seeks to redeem the ticket to enter the awarded redemption points into the selected customer redemption account.

The system 100 includes a mobile terminal 102 and a payment terminal 104. The other components of the system 100 which also facilitate the request to update redemption points recorded in a customer redemption account are omitted for the purposes of simplicity. The mobile terminal 102 may be a smart phone with an advanced mobile operating system, such as iOS of Apple Inc. or Android of Google Inc. The operating system hosts one or more VAS applications, developed for communicating with the payment terminal 104 to facilitate updating of a customer redemption account to which each of the VAS applications is designed to access.

The payment interface apparatus 104 is configured to facilitate a transaction initiated by the mobile terminal 102, the transaction including a request to update redemption points recorded in a customer redemption account. The payment interface apparatus 104 in FIG. 1 is realised by a payment terminal. The payment terminal is a device that is typically used to interface with payment cards, such as credit and debit cards. The payment terminal may also include a NFC (Near Field Communication) transceiver that receives and transmits data from and to the mobile terminal 102 so as to cater for payment, for example through the use of a digital wallet installed in the mobile terminal 102 which stores one or more credit or debit cards in electronic form. The NFC transceiver may also be used not only to facilitate such digital wallet payment, but also receive data used in conjunction with the request to update redemption points recorded in a customer redemption account.

Table 1 below summarises a list of APDU (application protocol data unit) commands that a VAS kernel 106 in the payment interface apparatus 104 uses to meet the request to update redemption points recorded in a customer redemption account.

TABLE 1
APDU commands executed by VAS kernel 106
APDU Supported

| APDU | | | Pres- | |
|---|---|---|---|---|
| Name | CLA | INS | ence | Description |
| Select | 00 | A4 | M | This command Selects the VAS module |
| | | | | on Mobile. Mobile will return a VAS |
| | | | | service identifier to Terminal, in order |
| | | | | for Terminal to active the right VAS |
| | | | | service. |
| Exchange | 90 | 50 | M | This command is used for the VAS data |
| Data | | | | exchange |
| Update | 90 | 52 | O | Only used if Terminal can update the |
| Coupon | | | | VAS module on Mobile of Coupon |
| Status | | | | status for 1-Tap use case model only |

A possible message exchange sequence which employs the APDU commands listed in Table 1 above is described below.

In a first step of the message exchange sequence, the VAS kernel 106 executes the select command of Table 1 to send 108 a signal detecting whether the mobile terminal 102 has, amongst its installed VAS applications, a VAS application configured to access the intended customer redemption account to which the request relates. Such identification is undertaken because the payment interface apparatus 104 is configured to accommodate one or more VAS service providers 114 using one or more dedicated communication channels 108, with each of the VAS service providers using their own protocol to process requests to update customer redemption accounts belonging to them. Thus, the correct VAS application has to be identified. Once the appropriate VAS application is identified in the mobile terminal 102, the mobile terminal 102 will return 108 an identifier of the VAS application to the VAS kernel 106 of the payment interface apparatus 104.

In a second step of the message exchange sequence, the VAS kernel 106 executes the Exchange Data command of Table 1 to perform an exchange 110 of data that is used to update redemption points in the intended customer redemption account.

In a third optional step of the message exchange sequence, the VAS kernel 106 executes the Update Coupon Status command of Table 1, where the VAS kernel 106 sends 112 a signal to the VAS application in the mobile terminal 102 to update a coupon status. This third optional step may be carried out in “single tap” scenarios, i.e. when the mobile terminal 102 is only required to be brought into proximity with the payment interface apparatus 104 once to complete all stages required to update redemption points recorded in a customer redemption account, i.e. from initiating the request, processing the request and receiving an indication that the redemption points in the customer redemption account is updated. The Update Coupon Status command is optional because the mobile terminal 102 can alternatively receive the indication that the redemption points in the customer redemption account has been updated from other channels, such as the VAS application in the mobile terminal 102 receiving this indication from a server maintaining the customer redemption account.

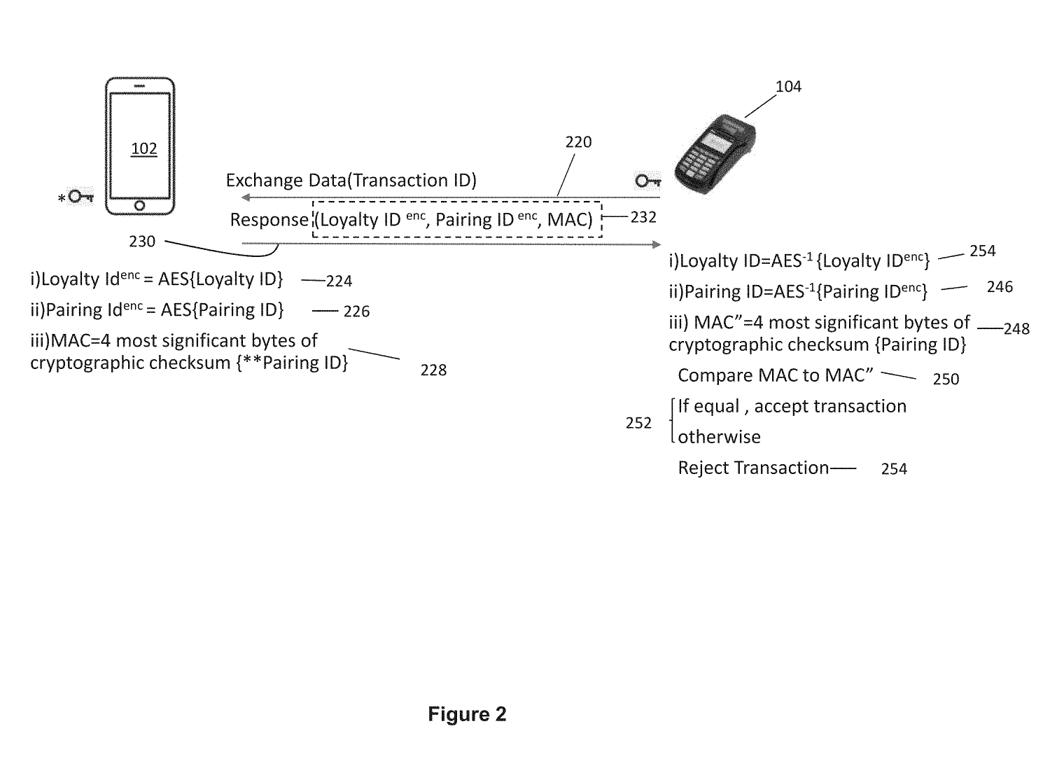

FIG. 2 shows further detail of the message exchange sequence that occurs when the Exchange Data command of Table 1 is executed. In FIG. 2, the mobile terminal 102 has already been placed in proximity to the payment interface apparatus 104, this proximity being within a distance where a sensor (such as a NFC transceiver) of the payment interface apparatus can detect the presence of the mobile terminal 102, and the payment interface apparatus 104 has already completed executed the select command of Table 1.

During the execution of the Exchange Data command, the payment interface apparatus 104 will transmit 220 a transaction identifier of the transaction initiated by the mobile terminal 102. This transaction identifier is typically the transaction serial number, being a unique number that can be used to identify the transaction from the numerous transactions that the payment interface apparatus 104 processes. Accordingly, the transaction identifier is one of several transaction specific parameters. Transaction specific parameters are data elements that are unique to the transaction, i.e. for all data present in messages exchanged between the mobile terminal 102 and the payment interface apparatus 104, such data elements are specifically generated on a per transaction basis to track that a communication session has occurred between the mobile terminal 102 and the payment interface apparatus 104 and are independent that the transaction includes a request to update redemption points.

The mobile terminal 102 concatenates the received transaction identifier with one or more data elements, such as the date and time the transaction is made at the payment interface apparatus 104 (i.e. the timestamp of the transaction) and a random number generated in accordance with a universally unique identifier (UUID) RFC 4122 standard. This random number is a segment of a 128-bit number, this 128-bit number being present simply because a communication channel is established between the payment interface apparatus 104 and the mobile terminal 102 during the transaction. The 128-bit number contains a reference to the mobile terminal 102, the timestamp of the transaction and the random number, the random number being generated specifically for the transaction.

The transaction specific parameters is used as a pairing identifier for the transaction between the payment interface apparatus 104 and the mobile terminal 102 because it forms the basis upon which authentication of the request to update redemption points recorded in a customer redemption account is based. The transaction specific parameters will be used in at least two ways. Firstly, the mobile terminal 102 will encrypt 226 the transaction specific parameters using an algorithm, such as one that is in accordance with the AES (advanced encryption standard) 16 byte key in ECB (electronic codebook) mode or 3DES (triple data encryption standard) to obtain encrypted transaction specific parameters. The session key to perform this encryption may be generated at the mobile terminal 102 or the mobile terminal 102 may obtain the session key from a cloud (not shown). It is also possible that the session key is obtained from the payment interface apparatus 104, for example together with the transmission 220 of the transaction identifier. Secondly, an authentication code MAC is generated 228 from the transaction specific parameters. This authentication code 228 may be created, for example, from using the four most significant bytes of a cryptographic checksum operation performed on the transaction specific parameters. An example of such a cryptographic checksum operation would be a message authentication code algorithm 1 n ISO/IEC 9797-1 with padding method 2.

The mobile terminal 102 will also obtain the customer redemption account number (shown as Loyalty ID in FIG. 2), that is to undergo the redemption point update, from the appropriate VAS application installed in the mobile terminal 102. This is done so as to provide the payment interface apparatus 104 with the customer redemption account number of the request. The mobile terminal 102 will encrypt 224 the customer redemption account number to obtain encrypted customer redemption account data before transmission to the payment interface apparatus 104. This encryption is done to ensure that data transmitted to the payment interface apparatus 104 cannot be read in plain, so that any unauthorised interception of data transmission to the payment interface apparatus 104 will merely obtain the encrypted customer redemption account data and not the customer redemption account number. The encryption may be done with the same algorithm as the one used to encrypt the transaction specific parameters.

The mobile terminal 102 will respond 230 to the transmission 220 of the transaction identifier with the request to update redemption points recorded in the customer redemption account and data fields 232 in support of the request. These received data fields 232 comprise the authentication code MAC and the encrypted transaction specific parameters. The received data fields 232 will also include the encrypted customer redemption account data, being encrypted from the customer redemption account number (see 224). The payment interface apparatus 104 will receive the request and the supporting data fields 232 through an input port.

The payment interface apparatus 104 will then determine whether the received request is genuine. This authentication of the request is based on a selection of at least the received data fields 232 that are attributable to transaction specific parameters, since the transaction specific parameters are data elements unique to the transaction carrying the request. The payment terminal 104 effects an update in the redemption points recorded in the customer redemption account in response to successful authentication of the request. When effecting the update, the payment terminal 104 may act as a router to inform a server maintaining the customer redemption account to record the necessary change in the redemption points stored in the customer redemption account, where the payment terminal 104 then relays the reply from the server to the mobile terminal 102 that the customer redemption account has been updated. Alternatively, the server may send this reply directly, without going through the payment terminal 104.

Authentication of the request can occur in the following manner. The payment interface apparatus 104 will decrypt 246 the encrypted transaction specific parameters to obtain the transaction specific parameters. The payment interface apparatus 104 will then generate 248 an authentication code MAC″ from the transaction specific parameters obtained as a result of the decryption in 246. During this generation 248, the authentication code MAC″ may be obtained from using the four most significant bytes of a cryptographic checksum operation performed on the transaction specific parameters. The generated authentication code MAC″ will be compared 250 with the received authentication code MAC. The request is authenticated 252 when it is determined that a match exists between the generated authentication code MAC″ and the received authentication code MAC. Successful authentication 252 would then lead to the encrypted customer redemption account data in the received data fields 232 being decrypted 254 to receive the customer redemption account number, which will be used to effect the update in the redemption points recorded in the customer redemption account. If no match exists, the transaction is rejected, whereby the decryption 254 may not occur.

Using a selection of data fields 232 that are attributable to data elements unique to the transaction as a criteria to authenticate a request to update redemption points recorded in a customer redemption account provides the following advantages. Given that these data elements, such as the transaction identifier and the timestamp of the transaction, are unique yet also dynamic (because the transaction identifier is determined by a sequential increase of the serial number of the preceding transaction, while the timestamp is determined by the moment the transaction is initiated), they provide an effective source upon which authentication of the transaction can be based. Thus, while the transaction specific parameters may use a selected set of data elements that are associated with the transaction, the resulting encrypted transaction specific parameters will be unique for each transaction because the value of these selected data elements change is different for each transaction session. In addition, as mentioned above, the transaction specific parameters also include a random number generated in accordance with the UUID RFC 4122 standard. Therefore the pairing identifier created from the transaction specific parameters has both a fixed component element, which is dynamic, and a random element. As a further security enhancement feature, not all of the transaction parameters are drawn from data elements from a single participant to the transaction. At least one of the data elements is drawn from both the mobile terminal 102 and the payment interface apparatus 104. In the example of FIG. 2, the at least one of these data elements drawn from the payment interface apparatus 104 is the transaction identifier, while the at least one of these data elements drawn from the mobile terminal 102 is the timestamp of the transaction and the UUID RFC 4122 random number. However, it will be appreciated that any one or more of the data elements from the mobile terminal 102 that are used for the transaction specific parameters can be obtained from the payment interface apparatus 104, such as the timestamp of the transaction.

Authentication using such a pairing identifier thus ensures that only a genuine receiver, namely the payment interface apparatus 204, is permitted to act on the request. Replay attacks can be prevented since it is difficult for an unauthorised party to replicate the authentication code MAC or MAC″, generated from such transaction specific parameter, since the authentication code MAC or MAC″ constantly changes. This is in comparison with basing authentication on a parameter like the customer redemption account number (which is constant), where the value of such a chosen parameter would always be the same.

The payment interface apparatus 104 may also be configured to receive, through the input port, a session key used in the decryption to obtain the transaction specific parameters from the received data fields 232. This session key may be obtained from a cloud, which also sends the session key to the mobile terminal 102 to perform the encryption of the transaction specific parameters at the mobile terminal 102 end. Alternatively, the session key is not received, but generated by the payment interface apparatus 104 and transmitted to the mobile terminal 102, as earlier mentioned. This same session key may also be used in the decryption 254 of the encrypted customer redemption account data. It will be appreciated that encryption and decryption of the transaction specific parameters is not limited to a symmetric approach, where the same session key is used to perform the encryption and decryption, as described thus far. It is also possible to use asymmetric approaches—such as a public key and a private key by RSA (Rivest Shamir Adleman) or ECC (elliptic curve cryptograph)—where it is the public key that is transmitted between the payment interface apparatus 104 and the mobile terminal 102.

While FIG. 2 shows use of a mobile terminal, it is possible that a payment card (not shown) initiates the transaction containing the request to update redemption points recorded in a customer redemption account. Examples of suitable payment cards include chip cards, where the payment cards have an integrated circuit having a set of electronic circuits with logic embedded therein that replicates the functions performed by a VAS application running in the mobile terminal 102 of FIG. 2. Such payment cards are typically passive devices. To activate their electronic circuits, power is drawn from an external source, such as the payment terminal 104 which reads the payment cards. When the payment card is used, one or more of the data fields which are used to support the request are generated by the payment interface apparatus 104. The payment interface apparatus 104 will receive the request when the payment card is placed in proximity to the sensor of the payment interface apparatus 104.

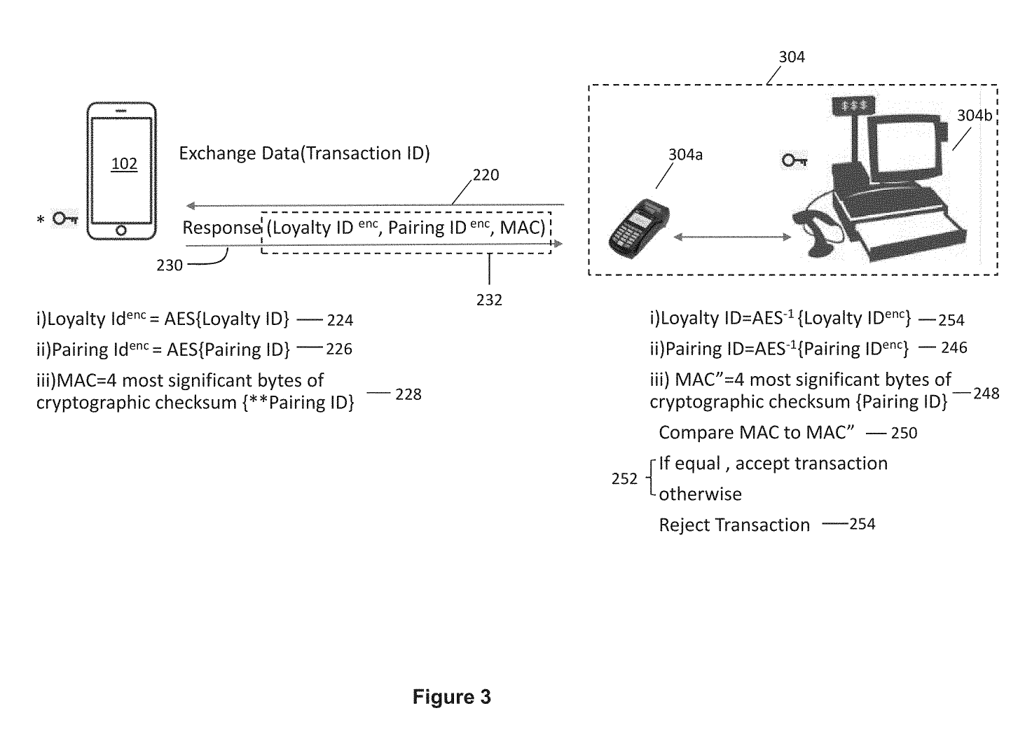

FIG. 3 shows the message exchange sequence that occurs when the Exchange Data command of Table 1 is executed, when the payment interface apparatus 304 includes a payment terminal 304a coupled to a point of sale (POS) terminal 304b. Like reference numerals used in FIG. 3 that are also found in FIG. 2 denote identical processes and are therefore not further elaborated.

The main difference between the components shown in FIG. 3 and that of FIG. 2 is that the payment interface apparatus 304 of FIG. 3 includes a payment terminal 304a coupled to a point of sale (POS) terminal 304b. The POS terminal 304b is a system that may include a computer, a cash register and other equipment that supports functions like inventory management and integration with a merchant backend system.

The payment terminal 304a acts as a bypass to forward the received request to update redemption points recorded in a customer redemption account and the supporting data fields 232 to the POS terminal 304b for processing the authentication of the request. Thus, the decryption 246 of the encrypted transaction specific parameters to obtain the transaction specific parameters; the generation 248 of the authentication code MAC″ from the transaction specific parameters obtained as a result of the decryption in 246; the comparison 250 of the generated authentication code MAC″ with the received authentication code MAC; and the authentication 252 of the request when a match exists between the generated authentication code MAC″ and the received authentication code MAC are performed by the POS terminal 304b. The decryption of the encrypted customer redemption account data in the received data fields 232 to receive the customer redemption account number, upon successful authentication 252, is also performed by the POS terminal 304b. Similarly, rejection 254 of the transaction, should no match exist, is also performed by the POS terminal 304b.

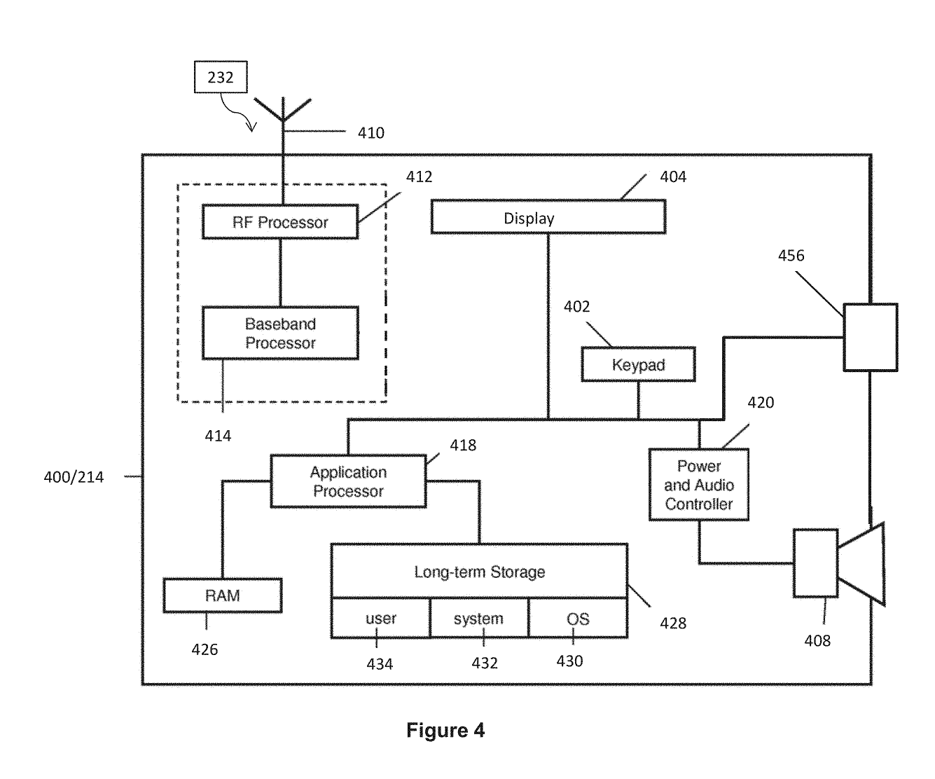

FIG. 4 is a schematic of a computing device 400 that may be utilized to implement the payment interface apparatus 104, 204 and 304 shown in FIGS. 1 to 3.

The computing device 400 comprises a keypad 402, a display 404, a speaker 408 and an antenna 410. Communication hardware that is used to enable NFC communication with the mobile terminal 102 is represented by RF processor 412 which provides an RF signal to the antenna 410 for the transmission of data signals, and the receipt therefrom. This antenna 410 provides the input port for receiving a transaction comprising a request to update redemption points recorded in a customer redemption account and the data fields 232 that are in support of the request. The received data fields 232 comprise an authentication code and encrypted transaction specific parameters. Additionally provided is a baseband processor 414, which provides signals to and receives signals from the RF Processor 412.

The keypad 402 and the display 404 are controlled by an application processor 418. The display 404 is used to provide an indication of the status of the payment interface apparatus 104/204/304, such as payment options available when the payment interface apparatus 104/204/304 detects that it is being used to receive electronic payment or that the payment interface apparatus 104/204/304 is processing payment after a payment option is selected through the keypad 402, A power and audio controller 420 is provided to supply power to the RF processor 412 and the baseband processor 414, the application processor 418, and other hardware. The power and audio controller 420 also controls audio output via the speaker 408. The speaker 408 is used to provide sounds to indicate that a data transaction with the payment interface apparatus 104/204/304 has been successfully completed.

In order for the application processor 418 to operate, various different types of memory are provided. Firstly, the computing device 400 includes Random Access Memory (RAM) 426 connected to the application processor 418 into which data and program code can be written and read from at will. Code placed anywhere in RAM 426 can be executed by the application processor 418 from the RAM 426. RAM 426 represents a volatile memory of the computing device 400.

Secondly, the computing device 400 is provided with a long-term storage 428 connected to the application processor 418. The long-term storage 428 comprises three partitions, an operating system (OS) partition 430, a system partition 432 and a user partition 434. The long-term storage 428 represents a non-volatile memory of the computing device 400.

In the present example, the OS partition 430 contains the firmware of the computing device 400 which includes an operating system. Other computer programs may also be stored on the long-term storage 428, such as application programs, and the like. In particular, application programs which are mandatory to the computing device 400 are typically stored in the system partition 432. The application programs stored on the system partition 432 would typically be those which are bundled with the computing device 400 by the device manufacturer when the computing device 400 is first sold. Application programs which are added to the computing device 400 by the user would usually be stored in the user partition 434.

The computing device 400 also comprises an image capturing module 456. The image capturing module, together with a suitable application, may be used to capture/scan QR codes and process the data embedded in the QR code. As an alternative to using NFC to transmit the request to update redemption points recorded in a customer redemption account, the mobile terminal 102 may generate a QR code containing a visual representation of the request and the supporting data fields 232 (see FIGS. 2 and 3), which are captured/scanned by the image capturing module 456. In this alternative implementation, the image capturing module 456 then serves as an additional input port to the payment interface apparatus 104/204/304.

To allow the payment interface apparatus 104/204/304 to facilitate a transaction comprising a request to update redemption points recorded in a customer redemption account, the application processor 418 and the at least one memory (e.g. RAM 426, long-term storage 428) with its computer program code are configured to cause the payment interface apparatus 104/204/304 at least to authenticate the request using a selection of at least the received data fields 232 that are attributable to transaction specific parameters, the transaction specific parameters being data elements unique to the transaction; and effect the update in the redemption points recorded in the customer redemption account in response to successful authentication of the request. During authentication of the request, the payment interface apparatus 104/204/304 is further configured to decrypt encrypted transaction specific parameters in the received data fields 232 to obtain the transaction specific parameters; generate an authentication code from the transaction specific parameters; and determine existence of a match between the generated authentication code and the authentication code in the received data fields 232, so as to effect the update in the redemption points recorded in the customer redemption account.

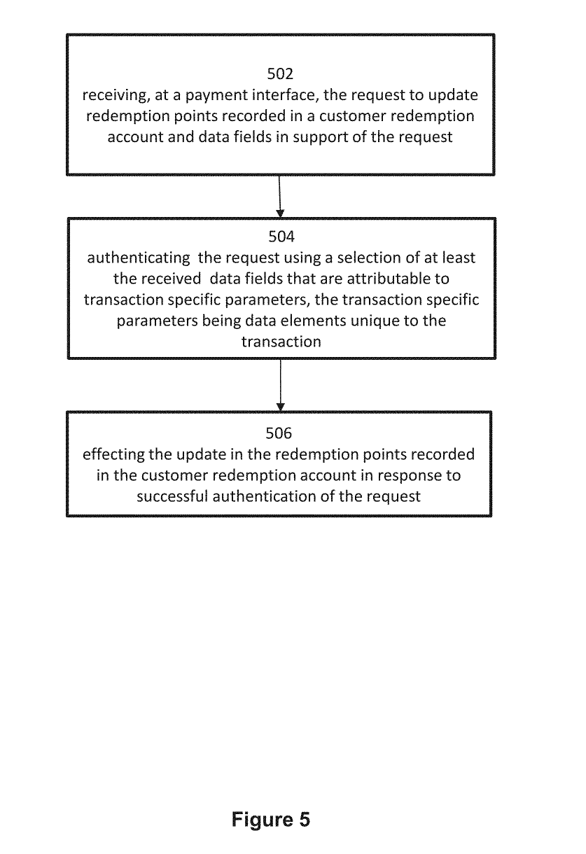

FIG. 5 shows a method, in accordance with one embodiment of the invention, for facilitating a transaction comprising a request to update redemption points recorded in a customer redemption account.

In step 502, a payment interface apparatus receives the request to update redemption points recorded in a customer redemption account and data fields in support of the request.

In step 504, the request is authenticated using a selection of at least the data fields that are attributable to transaction specific parameters, the transaction specific parameters being data elements unique to the transaction.

In step 506, an update in the redemption points recorded in the customer redemption account is effected, in response to successful authentication of the request.

Referring to both FIGS. 4 and 5, the payment interface apparatus 104/204/304 of FIG. 4 performs the method shown in FIG. 5 when the payment interface apparatus 104/204/304 executes instructions which may be stored in any one or more of the RAM 426 or the long-term storage 428. These components 426 and 428 provide a non-transitory computer readable medium having stored thereon executable instructions for controlling the payment interface apparatus 104/204/304 to perform steps comprising: a) receiving, at the payment interface apparatus 104/204/304, the request to update redemption points recorded in a customer redemption account and data fields in support of the request; b) authenticating the request using a selection of at least the received data fields that are attributable to transaction specific parameters, the transaction specific parameters being data elements unique to the transaction; and c) effecting the update in the redemption points recorded in the customer redemption account in response to successful authentication of the request.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A payment interface apparatus configured to facilitate a transaction comprising a request to update redemption points recorded in a customer redemption account, the payment interface apparatus comprising:
an input port to receive the request to update redemption points recorded in a customer redemption account and data fields in support of the request;
a processor; and
at least one memory including computer program code;
the at least one memory and the computer program code configured to, with the at least one processor, cause the payment interface apparatus at least to:
authenticate the request using a selection of at least the received data fields that are attributable to transaction specific parameters, the transaction specific parameters being data elements unique to the transaction; and
effect the update in the redemption points recorded in the customer redemption account in response to successful authentication of the request.

2. The payment interface apparatus of claim 1, wherein, during the authentication of the request, the payment interface apparatus is further configured to:
decrypt encrypted transaction specific parameters in the received data fields to obtain the transaction specific parameters;
generate an authentication code from the transaction specific parameters; and
determine existence of a match between the generated authentication code and an authentication code in the received data fields.

3. The payment interface apparatus of claim 1, wherein the received data fields further comprises encrypted customer redemption account data, being encrypted from the customer redemption account number

4. The payment interface apparatus of claim 1, wherein the transaction specific parameters comprise a concatenation of any one or more of a date and time the transaction is made at the payment interface apparatus; a transaction identifier of the transaction; and a random number generated in accordance with a universally unique identifier (UUID) RFC 4122 standard.

5. The payment interface apparatus of claim 2, wherein the payment interface apparatus is further configured to receive, through the input port, a session key used in the decryption to obtain the transaction specific parameters from the received data fields.

6. The payment interface apparatus of claim 2, wherein the generation of the authentication code at the payment interface apparatus further comprises performing a cryptographic checksum operation on the transaction specific parameters.

7. The payment interface apparatus of claim 1, wherein one or more of the data fields in support of the request are generated by the payment interface apparatus.

8. The payment interface apparatus of claim 1, wherein the payment interface apparatus further comprises a sensor, wherein the input port receives the request from any one or more of a mobile terminal and a payment card placed in proximity to the sensor.

9. The payment interface apparatus of claim 1, wherein the payment interface apparatus comprises a payment terminal or the payment terminal coupled to a point of sale (POS) terminal.

10. The payment interface apparatus of claim 9, wherein the payment terminal acts as a bypass to forward the received request and the data fields to the POS terminal for processing the authentication of the request.

11. A method for facilitating a transaction comprising a request to update redemption points recorded in a customer redemption account, the method comprising:
receiving, at a payment interface apparatus, the request to update redemption points recorded in a customer redemption account and data fields in support of the request;
authenticating the request using a selection of at least the received data fields that are attributable to transaction specific parameters, the transaction specific parameters being data elements unique to the transaction; and
effecting the update in the redemption points recorded in the customer redemption account in response to successful authentication of the request.

12. The method of claim 11, wherein, authentication of the request further comprises:
decrypting encrypted transaction specific parameters in the received data fields to obtain the transaction specific parameters;
generating an authentication code from the transaction specific parameters; and
determining existence of a match between the generated authentication code and an authentication code in the received data fields,

13. The method of claim 11, wherein the received data fields further comprises encrypted customer redemption account data, being encrypted from the customer redemption account number

14. The method of claim 11, wherein the transaction specific parameters comprise a concatenation of any one or more of a date and time the transaction is made at the payment interface apparatus; a transaction identifier of the transaction; and a random number generated in accordance with a universally unique identifier (UUID) RFC 4122 standard.

15. The method of claim 12, further comprising
receiving, at the payment interface apparatus, a session key used in the decryption to obtain the transaction specific parameters from the received data fields.

16. The method of claim 11, wherein the generation of the authentication code at the method further comprises performing a cryptographic checksum operation on the transaction specific parameters.

17. The method of claim 11, wherein one or more of the data fields in support of the request are generated by the payment interface apparatus.

18. The method of claim 11, wherein the payment interface apparatus receives the request from any one or more of a mobile terminal and a payment card placed in proximity to a sensor of the payment interface apparatus.

19. A non-transitory computer readable medium having stored thereon executable instructions for controlling a payment interface apparatus to facilitating a transaction comprising a request to update redemption points recorded in a customer redemption account by performing steps comprising
receiving, at a payment interface apparatus, the request to update redemption points recorded in a customer redemption account and data fields in support of the request;
authenticating the request using a selection of at least the received data fields that are attributable to transaction specific parameters, the transaction specific parameters being data elements unique to the transaction; and
effecting the update in the redemption points recorded in the customer redemption account in response to successful authentication of the request.
